(19) United States
(12) Patent Application Publication
(10) Pub. No.: US 2022/0345684 A1
(43) Pub. Date: Oct. 27, 2022

(54) Image Interpolation Method and Device Based on RGB-D Image and Multi-Camera System

(71) Applicant: PLEX-VR DIGITAL TECHNOLOGY (SHANGHAI) CO., LTD., Shanghai (CN)

(72) Inventors: YANSHUN ZHANG, Shanghai (CN); XIN CHEN, Shanghai (CN); YINGLIANG ZHANG, Shanghai (CN)

(73) Assignee: PLEX-VR DIGITAL TECHNOLOGY (SHANGHAI) CO., LTD., Shanghai (CN)

(21) Appl. No.: 17/855,751

(22) Filed: Jun. 30, 2022

Related U.S. Application Data
(63) Continuation of application No. PCT/CN2021/070574, filed on Jan. 7, 2021.

(30) Foreign Application Priority Data
Nov. 27, 2020 (CN) 202011355759.3

(51) Int. Cl. H04N 13/246; H04N 13/271; H04N 13/282

(52) U.S. Cl. CPC H04N 13/246; H04N 13/271; H04N 13/282

(57) ABSTRACT

The present invention discloses an image interpolation method and device based on RGB-D images and a multi-camera system, wherein the method comprises performing camera calibration on each camera in the multi-camera system; clarifying a position of a new camera for interpolation according to position information of the each camera in the multi-camera system, and calculating a camera pose of the new camera according to camera calibration data; calculating a plurality of initial interpolated images that have a one-to-one correspondence with designated images captured by the each camera of the multi-camera system according to a projection relationship of the camera and the pose information of the each camera; performing image fusion on each initial interpolated image to obtain a fused interpolated image; and performing pixel completion on the fused interpolated image so as to obtain an interpolated image related to the new camera.

### CROSS REFERENCE TO RELATED APPLICATIONS

This application is a continuation application of PCT Application No. PCT/CN2021/070574, filed on Jan. 7, 2021. The content of the application is incorporated herein by reference.

### BACKGROUND OF THE INVENTION

### 1. Field of the Invention

The present invention relates to an image interpolation method, and more particularly, to an image interpolation method and device based on RGB-D images and a multi-camera system.

### 2. Description of the Prior Art

Nowadays, multi-camera systems are widely used in 3D reconstruction, motion capture, and multi-view video shooting. The multi-camera system uses multiple different cameras, light sources, storage devices, etc. to track and shoot one or multiple targets at the same time, and the obtained multi-view video may further show the characteristics of the targets, which substantially improves the visual experience for the viewers. However, the multi-view video may usually only be watched from the viewpoint of the original capture camera. When the capture cameras are deployed sparsely, the view angle switch would cause a large content change, which makes the viewer sense the video choppy.

### SUMMARY OF THE INVENTION

The present invention proposes an image interpolation method and a device based on RGB-D images and a multi-camera system to solve the problem that due to the insufficient amount of capture cameras the view angle switch would cause the video choppy.

To achieve this purpose, the present invention adopts the following technical solutions:

An image interpolation method based on RGB-D images and a multi-camera system is provided, and the method comprises:

1) performing camera calibration on each camera in the multi-camera system;

2) clarifying a position of a new camera for interpolation according to position information of the each camera in the multi-camera system, and calculating a camera pose of the new camera according to camera calibration data obtained in step 1);

3) calculating a plurality of initial interpolated images that have a one-to-one correspondence with designated images captured by the each camera of the multi-camera system according to a projection relationship of the camera and the pose information of the each camera;

4) performing image fusion on each initial interpolated image to obtain a fused interpolated image; and

5) performing pixel completion on the fused interpolated image so as to obtain an interpolated image related to the new camera.

Preferably, the camera pose of the new camera in step 2) comprises a camera intrinsic matrix, a camera translation vector, and a camera rotation matrix, and the camera intrinsic matrix of the new camera is calculated by the following equation (1):

K′=(1−λ)K₁+λK₂ (1)

wherein, in equation (1), K′ represents the camera intrinsic matrix of the new camera;

λ is used to represent the position of the new camera for interpolation, and λ is a ratio of the distance between the new camera and a left camera to the total distance between the left camera and a right camera, 0≤λ≤1;

K₁ represents a camera intrinsic matrix of the left camera which is set on the left side of the new camera; and

K₂ represents a camera intrinsic matrix of the right camera which is set on the right side of the new camera.

Preferably, the camera translation vector of the new camera is calculated by the following equation (2):

T′=(1−λ)T₁+λT₂ (2)

wherein, in equation (2), T′ represents the camera translation vector of the new camera;

T₁ represents a camera translation vector of the left camera; and

T₂ represents a camera translation vector of the right camera.

Preferably, the specific steps of calculating the camera rotation matrix of the new camera comprise:

2.1) calculating a first relative rotation matrix of the right camera relative to the left camera through camera rotation matrices of the left camera and the right camera;

2.2) converting the first relative rotation matrix to a first relative rotation vector, wherein the first relative rotation vector is represented by a rotation axis r=[rₓ,r_{y},r_{z}]^{T} and a rotation angle θ;

2.3) calculating a product of the rotation angle θ and the ratio λ as a rotation angle θ′ of the new camera relative to the left camera, wherein the rotation angle θ′ and the same rotation axis r as the first relative rotation vector are used to represent a second relative rotation vector of the new camera relative to the left camera;

2.4) converting the second relative rotation vector to a second relative rotation matrix; and

2.5) reversely calculating the camera rotation matrix of the new camera according to the second relative rotation matrix and the rotation matrix of the left camera.

Preferably, the process of calculating the camera rotation matrix of the new camera is represented by the following equation (3):

R′=R₁(Mᵥ₂ᵣ(λMᵣ₂ᵥ(R₂⁻¹·R₁)))⁻¹ (3)

wherein, in equation (3), R′ represents the camera rotation matrix of the new camera;

Mᵥ₂ᵣ represents converting from the first relative rotation matrix to the first relative rotation vector;

Mᵣ₂ᵥ represents converting from the second relative rotation vector to the second relative rotation matrix;

R₁ represents the camera rotation matrix of the left camera transformed from a camera coordinate system to a world coordinate system; and

R₂ represents the camera rotation matrix of the right camera transformed from the camera coordinate system to the world coordinate system.

Preferably, the specific steps of calculating the initial interpolated image in step 3) comprise:

3.1) building a projection matrix of the each camera;

3.2) obtaining a three-dimensional discrete point S by back-projecting the built camera projection matrix according to all pixel coordinates and depth values of the designated image captured by a designated camera;

3.3) calculating a pixel coordinate of an image to be generated according to the pose information of the designated camera and the new camera, the three-dimensional discrete point, and the camera projection matrix of the new camera;

3.4) according to the correspondence of the coordinates of the pixel points between the designated image and the image to be generated, filling the pixel value and depth value of the designated image to the corresponding pixel points of the image to be generated so as to obtain the initial interpolated image which has a correspondence with the designated image; and

3.5) repeating steps 3.2) to 3.4) until the plurality of initial interpolated images that have the one-to-one correspondence with the designated images captured by all cameras of the multi-camera system are obtained.

Preferably, the pixel coordinates of the image to be generated in step 3.3) are calculated by the following equation (4):

$${u}^{′} = \frac{x}{{d}^{′}} {v}^{′} = \frac{y}{{d}^{′}} \qquad ( 4 )$$

wherein, in equation (4), u′ represents a coordinate of the pixel of the image to be generated on the x-axis;

v′ represents a coordinate of the pixel of the image to be generated on the y-axis;

d′ represents a depth value corresponding to the pixel at the position coordinate of u′, v′;

wherein x and y in equation (4) are calculated by the following equation (5):

$$[ \begin{matrix}x \\ y \\ {d}^{′} \\ 1\end{matrix} ] = {P}^{′} {P}_{1}^{- 1} [ \begin{matrix}{u}_{1} {d}_{1} \\ {v}_{1} {d}_{1} \\ {d}_{1} \\ 1\end{matrix} ] \qquad ( 5 )$$

wherein, in equation (5), u′, v′ represent the position coordinate of the pixel of the designated image, u₁ represents a coordinate of the pixel of the designated image on the x-axis, and v₁ represents a coordinate of the pixel of the designated image on the y-axis;

P₁ represents the camera projection matrix of the designated camera;

P′ represents the camera projection matrix of the new camera; and

d₁ represents a depth value corresponding to the pixel at the position coordinate of u₁, v₁.

Preferably, when there are multiple pixel points projected from the same designated image to the image to be generated at the same position coordinate, only a pixel value of the pixel with the smallest depth value d′ is kept as the pixel value of the pixel point of the image to be generated at the position coordinate.

Preferably, the method of performing image fusion on the each initial interpolated image in step 4) comprises:

4.1) determining whether the pixel values of the pixels at the same position of the each initial interpolated image are all empty,

if yes, entering an image completion process; and

if no, going to step 4.2);

4.2) determining whether the number of the initial interpolated images with non-empty pixel values at the same position is 1,

if yes, assigning the non-empty pixel value to the pixel at the same position of the fused interpolated image; and

if no, go to step 4.3); and

4.3) calculating the difference of the depth values between the pixels with non-empty pixel values at the same position of the initial interpolated images, and selecting the corresponding pixel value assignment method according to the threshold judgment result through a threshold judgment method so as to assign the pixel values of the initial interpolated image to the fused interpolated image.

Preferably, the specific method of assigning the pixel values of the initial interpolated image to the fused interpolated image in step 4.3) comprises:

if an absolute value of the difference between the depth values of the pixels at the same position of a right image captured by the right camera and a left image captured by the left camera is smaller than or equal to a set threshold ϵ, assigning a weighted average of pixel values of the left image and the right image at the same location to a corresponding pixel point of the fused interpolated image;

if a difference between the pixel values at the same position of the right image and the left image is greater than the threshold ϵ, assigning the pixel value at the same position of the left image to the corresponding pixel point of the fused interpolated image; and

if the difference between the pixel values at the same position of the left image and the right image is smaller than the threshold ϵ, assigning the pixel value at the same position of the right image to the corresponding pixel point of the fused interpolated image.

Preferably, the steps of performing pixel completion on the fused interpolated image specifically comprise:

5.1) generating a window W with the position of the empty pixel as the center;

5.2) calculating an average pixel value of all non-empty pixels inside the window W;

5.3) filling the average pixel value to the center pixel point determined in step 5.1); and

5.4) repeating steps 5.1) to 5.3) until that the pixel completions for all empty pixels of the fused interpolated image are completed.

The present invention further provides an image interpolation device based on RGB-D images and a multi-camera system, and the image interpolation device comprises:

a camera calibration module, configured to perform camera calibration on each camera in the multi-camera system;

a new camera pose calculation module, coupled to the camera calibration module and configured to clarify a position of a new camera according to position information of the each camera in the multi-camera system, and to calculate a camera pose of the new camera according to camera calibration data;

an initial interpolated image calculation module, coupled to the new camera pose calculation module, configured to calculate a plurality of initial interpolated images that have a one-to-one correspondence with designated images captured by the each camera in the multi-camera system according to a projection relationship of the camera and the pose information of the each camera;

an image fusion module, coupled to the initial interpolated image calculation module, configured to perform image fusion on the each initial interpolated image so as to obtain a fused interpolated image; and

an image completion module, coupled to the image fusion module, configured to perform pixel completion on the fused interpolated image and finally obtain an interpolated image associated with the new camera.

The present invention has the following beneficial effects:

1. Image interpolation may be performed at any linear position between cameras, and the shooting effect of multiple cameras may be achieved with only few cameras, which saves the shooting cost.

2. With a small number of cameras, a multi-view video may be performed like viewing with dense viewpoints. As a result, switch of the video viewpoints would not stutter, and may be more smoothly. Moreover, the reduction of the image number is beneficial to improve the data transmission speed of the multi-camera system.

3. The parallel computing method is adopted to calculate the pixel value of each pixel of the interpolated image, and therefore the calculation speed of the interpolated image is improved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

In order to more clearly illustrate the technical solutions of the embodiments of the present invention, the accompanying figures required in the embodiments of the present invention will be briefly described below. Obviously, the accompanying figures described below are merely some embodiments of the present invention, and those of ordinary skill in the art may derive other figures according to these accompanying figures without any inventive effort.

FIG. 1 is a flowchart of an image interpolation method based on RGB-D images and a multi-camera system provided by an embodiment of the present invention;

FIG. 2 is a flowchart of a method for calculating a camera rotation matrix of a new camera;

FIG. 3 is a flowchart of a specific method for calculating the said initial interpolated image.

FIG. 4 is a flowchart of a method for performing image fusion on each of the described initial interpolated image.

FIG. 5 is a schematic diagram of calculating the position of a new camera.

FIG. 6 is a principle diagram for calculating the initial interpolated image.

FIG. 7 is a flowchart of a method for performing pixel completion on the described fusion interpolated image.

FIG. 8 is a schematic diagram of an internal logical structure of an image interpolation device based on an RGB-D image and a multi-camera system provided by an embodiment of the present invention.

### DETAILED DESCRIPTION

The technical solutions of the present invention are further described below through specific embodiments with reference to the accompanying figures.

Wherein, the accompanying figures are only for exemplary illustration and represent only schematic diagrams, not actual pictures, and should not be construed as limitations on the present patent. In order to illustrate embodiments of the present invention better, some components of the accompanying figures will be omitted, enlarged or reduced, and do not represent the actual size of the product. It is understandable to those skilled in the art that certain well-known structures in the accompanying figures and the descriptions thereof may be omitted.

The same or similar labels in the accompanying figures of the embodiments of the present invention are corresponding to the same or similar components. In the description of the present invention, it should be understood that if the terms indicating orientation or positional relationship, such as “up”, “down”, “left”, “right”, “inside”, “outside”, etc., appear, the indicated orientation or positional relationship is based on the accompanying figures, which is only for the convenience of describing the present invention and simplifying the description, rather than indicating or implying that the indicated device or component must have a specific orientation or be constructed and operated in a specific orientation. Therefore, the terms describing the positional relationship in the accompanying figures are only used for exemplary illustration, and should not be construed as a limitation on the present patent. Those skilled in the art may understand the specific meanings of the above terms according to the actual condition.

In the description of the present invention, unless further expressly specified and limited, if the term “couple” or the like appears to indicate a connection relationship between components, the term should be interpreted in a broad sense such as a fixed connection, a detachable connection or be monolithic; a mechanical connection or an electrical connection; a direct connection or an indirect connection through intermediate medium; an internal connection between two components or an interaction relationship between the two components. Those of ordinary skill in the art may understand the specific meanings of the above terms in the present invention according to the actual condition.

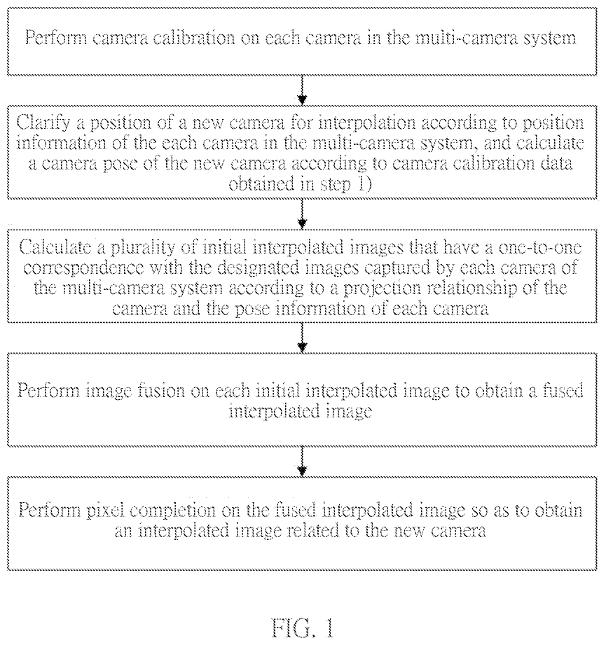

An image interpolation method based on RGB-D images and a multi-camera system provided by an embodiment of the present invention is shown in FIG. 1, and includes the following steps:

1) Perform camera calibration on each camera in the multi-camera system to obtain intrinsics and extrinsics of the camera, and the intrinsic matrix K is represented by the following 3×3 matrix:

$$K = [ \begin{matrix}{f}_{x} & 0 & {c}_{x} \\ 0 & {f}_{y} & {c}_{y} \\ 0 & 0 & 1\end{matrix} ]$$

where fₓ represents a focal length of the camera in the x-axis, in pixels;

f_{y} represents a focal length of the camera in the y-axis, in pixels;

cₓ is the coordinate of the image principal point on the x-axis, in pixels;

c_{y} is the coordinate of the image principal point on the y-axis, in pixels.

The extrinsic matrix is a 3×4 matrix [R|T] composed of a 3×3 rotation matrix R and a 3×1 translation vector T.

2) Clarify a position of a new camera for interpolation according to position information of the each camera in the multi-camera system, and calculate a camera position of the new camera according to camera calibration data obtained in step 1).

The method for defining the camera position of the new camera adopted by the present invention is as follows:

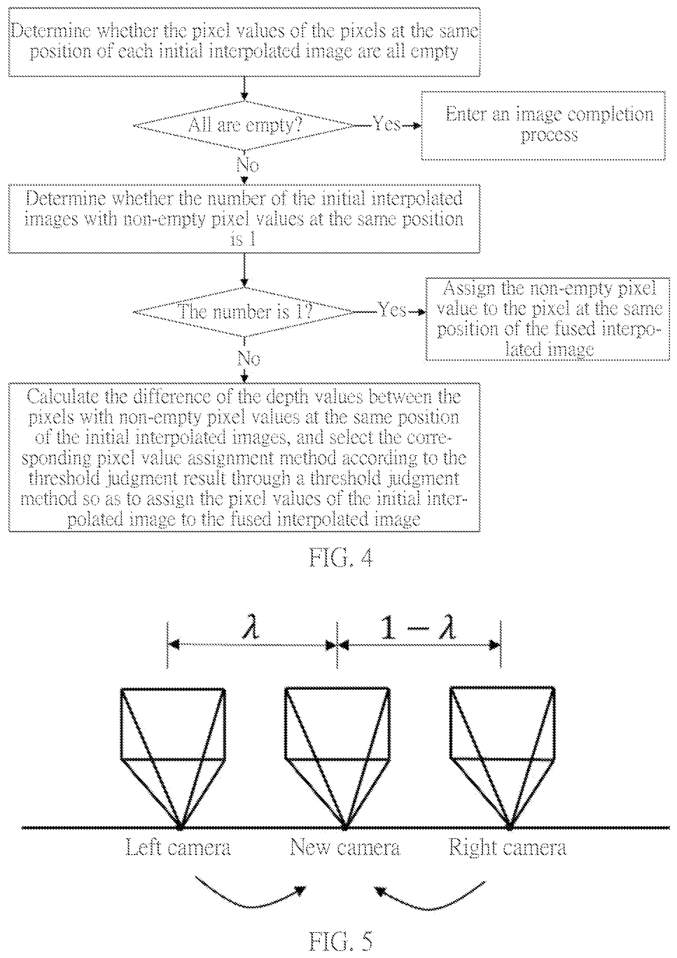

As shown in FIG. 5, in a camera trajectory, take any two adjacent cameras as an example, one is marked as a left camera and the other is marked as a right camera, and the new camera is interpolated in a position which is the line segment between the two points of the left camera and the right camera. The position of the new camera for interpolation is represented by a ratio λ, and the calculation method of the specific setting position of the new camera is a ratio of the distance between the new camera and the left camera to the total distance between the left camera and the right camera, where the ratio is represented by λ. When the new camera is located in the same position with the left camera, λ=0; on the other hand, when the new camera is located in the same position with the right camera, λ=1. Consequently, when the new camera is in the position between the left camera and the right camera, 0≤λ≤1.

A camera pose of the new camera comprises a camera intrinsic matrix, a camera translation vector, and a camera rotation matrix, and the camera translation vector and the camera rotation matrix of the new camera constitute a camera extrinsic matrix of the new camera. The camera intrinsic matrix of the new camera is calculated by the following equation (1):

K′=(1−λ)K₁+λK₂ (1)

In equation (1), K′ represents the camera intrinsic matrix of the new camera;

λ is used to represent the position of the new camera for interpolation, λ is the ratio of the distance between the new camera and the left camera to the total distance between the left camera and the right camera, 0≤λ≤1;

K₁ represents a camera intrinsic matrix of the left camera which is set on the left side of the new camera;

K₂ represents a camera intrinsic matrix of the right camera which is set on the right side of the new camera.

The camera translation vector of the new camera is calculated by the following equation (2):

T′=(1−λ)T₁+λT₂ (2)

In equation (2), T′ represents the camera translation vector of the new camera;

T₁ represents a camera translation vector of the left camera;

T₂ represents a camera translation vector of the right camera.

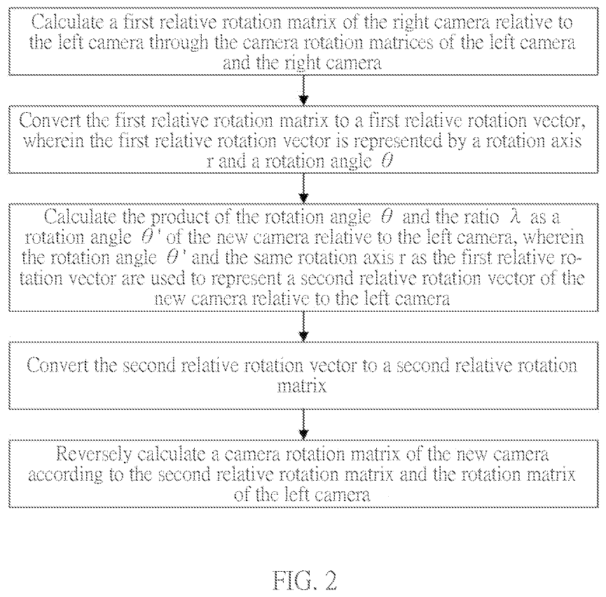

As shown in FIG. 2, the calculation process of the camera rotation matrix of the new camera specifically comprises the following steps:

2.1) Calculate a first relative rotation matrix of the right camera relative to the left camera through the camera rotation matrices of the left camera and the right camera;

2.2) Convert the first relative rotation matrix to a first relative rotation vector, wherein the first relative rotation vector is represented by a rotation axis r=[rₓ,r_{y},r_{z}]^{T} and a rotation angle θ;

2.3) Calculate the product of the rotation angle θ and the ratio λ as a rotation angle θ′ of the new camera relative to the left camera, wherein the rotation angle θ′ and the same rotation axis r as the first relative rotation vector are used to represent a second relative rotation vector of the new camera relative to the left camera;

2.4) Convert the second relative rotation vector to a second relative rotation matrix;

2.5) Reversely calculate the camera rotation matrix of the new camera according to the second relative rotation matrix and the rotation matrix of the left camera.

The above process of calculating the camera rotation matrix of the new camera may be represented by the following equation (3):

R′=R₁(Mᵥ₂ᵣ(λMᵣ₂ᵥ(R₂⁻¹·R₁))) (3)

In equation (3), R′ represents the camera rotation matrix of the new camera;

Mᵥ₂ᵣ represents converting from the first relative rotation matrix to the first relative rotation vector; the process of converting the first relative rotation matrix to the first relative rotation vector may be represented by the following equation (10):

$$sin θ [ \begin{matrix}0 & - {r}_{z} & {r}_{y} \\ {r}_{z} & 0 & - {r}_{x} \\ - {r}_{y} & {r}_{x} & 0\end{matrix} ] = \frac{R - {R}^{T}}{2} \qquad ( 10 )$$

Mᵣ₂ᵥ represents converting from the second relative rotation vector to the second relative rotation matrix; the process of converting the second relative rotation vector to the second relative rotation matrix may be represented by the following equation (11):

$$R = cos ( θ ) I + ( 1 - cos ( θ ) ) r {r}^{T} + sin ( θ ) [ \begin{matrix}0 & - {r}_{z} & {r}_{y} \\ {r}_{z} & 0 & - {r}_{x} \\ - {r}_{y} & {r}_{x} & 0\end{matrix} ] \\ θ ← {‖ r ‖}_{2} r ← r / θ \qquad ( 11 )$$

R₁ represents the camera rotation matrix of the left camera transformed from the camera coordinate system to the world coordinate system;

R₂ represents the camera rotation matrix of the right camera transformed from the camera coordinate system to the world coordinate system.

Please continue to refer to FIG. 1. The image interpolation method based on the RGB-D images and the multi-camera system provided by the present invention further includes:

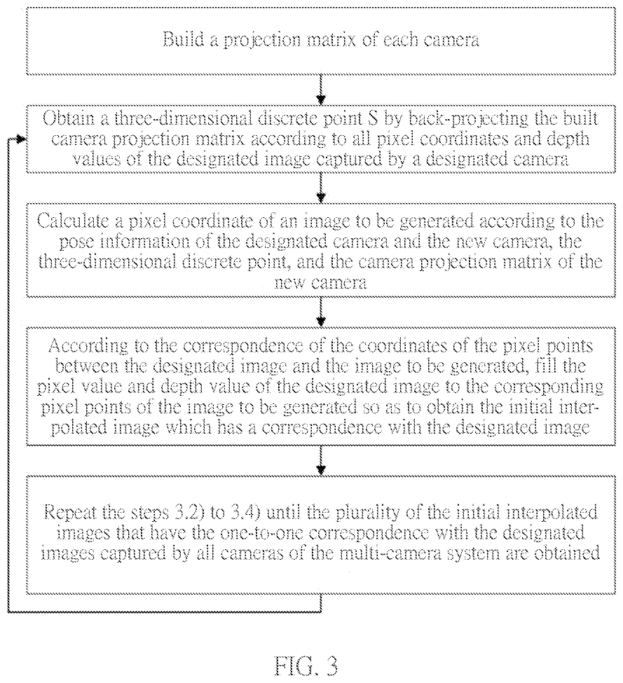

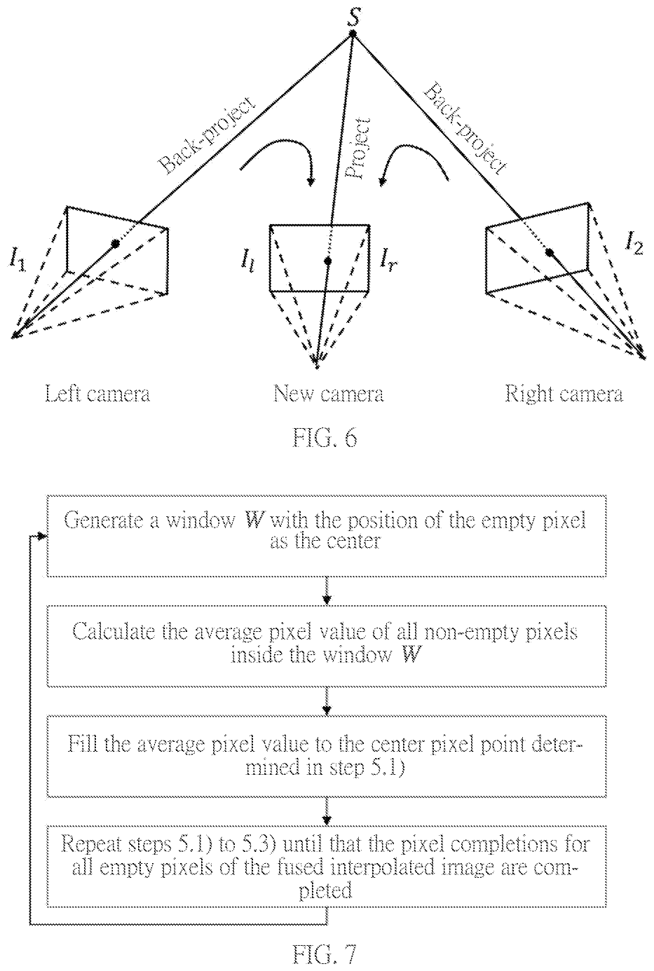

3) Calculate a plurality of initial interpolated images that have a one-to-one correspondence with the designated images captured by each camera of the multi-camera system according to a projection relationship of the camera and the pose information of each camera. As shown in FIG. 3 and FIG. 6, the specific steps of calculating the initial interpolated image include:

3.1) Build a projection matrix of each camera; the projection matrix P of each camera may be calculated by the following equation (12):

$$P = [ \begin{matrix}K & 0 \\ {0}^{T} & 1\end{matrix} ] [ \begin{matrix}R & T \\ {0}^{T} & 1\end{matrix} ] \qquad ( 12 )$$

In equation (12), K represents the intrinsic matrix of the camera;

R represents a rotation matrix of the camera transformed from the world coordinate system to the camera coordinate system;

T represents a translation vector of the camera transformed from the world coordinate system to the camera coordinate system. The transformation between the camera coordinate system and the world coordinate system may be calculated by the following equation (13):

R_{w2c}=R_{c2w}⁻¹

T_{w2c}=−R_{c2w}⁻¹T_{c2w} (13)

In equation (13), R_{w2c} represents the rotation matrix transformed from the world coordinate system to the camera coordinate system;

T_{w2c} represents the translation vector transformed from the world coordinate system to the camera coordinate system; R_{c2w} represents the rotation matrix transformed from the camera coordinate system to the world coordinate system; T_{c2w} represents the translation vector transformed from the camera coordinate system to the world coordinate system.

3.2) Obtain a three-dimensional discrete point S by back-projecting the built camera projection matrix according to all pixel coordinates and depth values of the designated image captured by a designated camera;

3.3) Calculate a pixel coordinate of an image to be generated (i.e., the initial interpolated image) according to the pose information of the designated camera and the new camera and the camera projection matrix of the new camera;

3.4) According to the correspondence of the coordinates of the pixel points between the designated image and the image to be generated, fill the pixel value and depth value of the designated image to the corresponding pixel points of the image to be generated so as to obtain the initial interpolated image which has a correspondence with the designated image;

3.5) Repeat the steps 3.2 to 3.4 until the plurality of initial interpolated images that have the one-to-one correspondence with the designated images captured by all cameras of the multi-camera system are obtained.

The following is an example of setting the new camera between the left camera and the right camera, and the calculation process of the initial interpolated image is described along with FIG. 6.

First, an image captured by the left camera is noted as a left image (i.e., the designated image), and a three-dimensional discrete point S is obtained by back-projecting the built camera projection matrix according to all pixel coordinates and depth values of the left image. Then, the process projects according to the projection matrix of the new camera, and uses the correspondence of the pose information between the left camera and the new camera to project the pixel coordinates of the image to be generated (the interpolated image). And then, the process fills the pixel value of the left image to the corresponding pixel point of the image to be generated. If there are multiple pixels of the left image that are projected to the same pixel of the image to be generated, only the pixel value with the smallest depth value after projection is kept. The initial interpolated RGB image Iₗ is obtained, and the initial interpolated depth map Dₗ is obtained at the same time. Finally, with the same interpolation method, the process obtains the initial interpolated RGB image Iᵣ and the initial interpolated depth map Dᵣ according to the back-projection and projection of the right image captured by the right camera.

In the above step 3.3), the pixel coordinates of the image to be generated are calculated by the following equation (4):

$${u}^{′} = \frac{x}{{d}^{′}} {v}^{′} = \frac{y}{{d}^{′}} \qquad ( 4 )$$

In equation (4), u′ represents the coordinate of the pixel of the image to be generated on the x-axis;

v′ represents the coordinate of the pixel of the image to be generated on the y-axis;

d′ represents the depth value corresponding to the pixel at the position coordinate of u′, v′.

x and y in equation (4) are calculated by the following equation (5):

$$[ \begin{matrix}x \\ y \\ {d}^{′} \\ 1\end{matrix} ] = {P}^{′} {P}_{1}^{- 1} [ \begin{matrix}{u}_{1} {d}_{1} \\ {v}_{1} {d}_{1} \\ {d}_{1} \\ 1\end{matrix} ] \qquad ( 5 )$$

In equation (5), u′, v′ represent the position coordinate of the pixel of the designated image, u₁ represents the coordinate of the pixel of the designated image on the x-axis, and v₁ represents the coordinate of the pixel of the designated image on the y-axis;

P₁ represents the camera projection matrix of the designated camera;

P′ represents the camera projection matrix of the new camera;

d₁ represents the depth value corresponding to the pixel at the position coordinate of u₁, v₁.

Please continue to refer to FIG. 1. The image interpolation method based on the RGB-D images and the multi-camera system provided by the present invention further includes: Step 4) Perform image fusion on each initial interpolated image to obtain a fused interpolated image.

Specifically, as shown in FIG. 4, the specific steps of fusing each initial interpolated image include:

4.1) Determine whether the pixel values of the pixels at the same position of each initial interpolated image are all empty,

if yes, enter an image completion process;

if no, go to step 4.2);

4.2) Determine whether the number of the initial interpolated images with non-empty pixel values at the same position is 1,

if yes, assign the non-empty pixel value to the pixel at the same position of the fused interpolated image;

if no, go to step 4.3);

4.3) Calculate the difference of the depth values between the pixels with non-empty pixel values at the same position of the initial interpolated images, and select the corresponding pixel value assignment method according to the threshold judgment result through a threshold judgment method so as to assign the pixel values of the initial interpolated image to the fused interpolated image.

In step 4.3), the specific method of assigning the pixel values of the initial interpolated image to the fused interpolated image is as follows:

If the absolute value of the difference between the depth values of the pixels at the same position of the right image captured by the right camera and the left image captured by the left camera is smaller than or equal to a set threshold ϵ, assign a weighted average of pixel values of the left image and the right image at the same location to a corresponding pixel point of the fused interpolated image;

If the difference between the pixel values at the same position of the right image and the left image is greater than the threshold ϵ, assign the pixel value at the same position of the left image to the corresponding pixel point of the fused interpolated image; If the difference between the pixel values at the same position of the left image and the right image is smaller than the threshold ϵ, assign the pixel value at the same position of the right image to the corresponding pixel point of the fused interpolated image.

Specifically, the present invention fuses the pixel values at the same position of the initial interpolated images Iₗ and Iᵣ obtained from the left image and the right image respectively according to the following three criteria:

If the pixel value of the initial interpolated image Iₗ is not empty, and the pixel value of the initial interpolated image Iᵣ is empty at the same position, then assign the pixel value at the position of the initial interpolated image Iₗ to the fused interpolated image. The fusion process may be represented by the following equation (6):

I′(i,j)=Iₗ(i,j), if Iₗ(i,j)≠0 and Iᵣ(i,j)=0 (6)

In equation (6), I′(i,j) represents the fused interpolated image;

i, j represents the position coordinate of the pixel of the initial interpolated image or the fused interpolated image.

If the pixel value of the initial interpolated image Iᵣ is not empty, and the pixel value of the initial interpolated image Iₗ is empty at the same position, then assign the pixel value at the position of the initial interpolated image Iᵣ to the fused interpolated image. The fusion process may be represented by the following equation (7):

I′(i,j)=Iᵣ(i,j), if Iᵣ(i,j)≠0 and Iₗ(i,j)=0 (7)

If both of the pixel values of the initial interpolated image Iₗ and the initial interpolated image Iᵣ at the same position are not empty, calculate the difference of the depth values between the pixels at the same position, and select the corresponding pixel value assignment method according to the threshold judgment result through the threshold judgment method so as to assign the pixel values of the initial interpolated image to the fused interpolated image. The specific interpolation process may be represented by the following equation (8):

$${I}^{′} ( i , j ) = \{ \begin{matrix}{I}_{l} ( i , j ) & if ( {D}_{r} ( i , j ) - {D}_{l} ( i , j ) ) > ϵ \\ {I}_{r} ( i , j ) & if ( {D}_{l} ( i , j ) - {D}_{r} ( i , j ) ) > ϵ \\ ( 1 - λ ) {I}_{l} ( i , j ) + λ {I}_{r} ( i , j ) & if \vert {D}_{r} ( i , j ) - {D}_{l} ( i , j ) \vert \leq ϵ\end{matrix} \qquad ( 8 )$$

In equation (8), Dᵣ(i,j) represents the initial interpolated depth map of the right image;

Dₗ(i,j) represents the initial interpolated depth map of the right image;

Iₗ(i,j) represents the initial interpolated RGB image projected by the left image;

Iᵣ(i,j) represents the initial interpolated RGB image projected by the right image.

In step 5), when determining that the pixel value of the pixel at the same position of each initial interpolated image is empty, as shown in FIG. 7, the steps of performing pixel completion on the pixel at the corresponding position of the fused interpolated image specifically include:

5.1) Generate a window W with the position of the empty pixel as the center;

5.2) Calculate the average pixel value of all non-empty pixels inside the window W;

5.3) Fill the average pixel value to the center pixel point determined in step 5.1);

5.4) Repeat steps 5.1) to 5.3) until that the pixel completions for all empty pixels of the fused interpolated image are completed.

The above pixel completion process may be represented by the following equation (9):

$$I ( i , j ) = \frac{{\sum }_{Δ x Δ y ∈ W} {I}^{′} ( i + Δ x , j + Δ y )}{card ( W )} , if {I}^{′} ( i , j ) = 0 \qquad ( 9 )$$

In equation (9), I(i,j) represents the fused interpolated image after pixel completion;

Δx, Δy represents the offsets in the x-direction and y-direction of the window W relative to the center pixel point;

card(W) represents the number of effective pixels in the window W;

I′(i,j) represents the fused interpolated image without image completion.

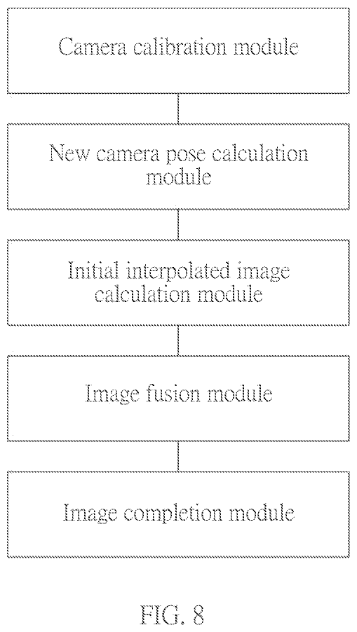

The present invention further provides an image interpolation device based on RGB-D images and a multi-camera system as shown in FIG. 8, and the device comprises:

A camera calibration module, configured to perform camera calibration on each camera in the multi-camera system;

A new camera pose calculation module, coupled to the camera calibration module and configured to clarify the position of the new camera according to the position information of each camera in the multi-camera system, and to calculate the camera pose of the new camera according to the camera calibration data;
An initial interpolated image calculation module, coupled to the new camera pose calculation module, configured to calculate a plurality of initial interpolated images that have a one-to-one correspondence with the designated images captured by each camera in the multi-camera system according to the projection relationship of the camera and the pose information of each camera;
An image fusion module, coupled to the initial interpolated image calculation module, configured to perform image fusion on each initial interpolated image so as to obtain a fused interpolated image;
An image completion module, coupled to the image fusion module, configured to perform pixel completion on the fused interpolated image and finally obtain an interpolated image associated with the new camera.

It is to be declared that the above-mentioned specific embodiments are only preferred embodiments of the present invention and the applied technical principles. Those skilled in the art should understand and made various modifications, equivalent alternatives, changes to the present invention. However, as long as the derivatives do not depart from the spirit of the present invention, the derivatives should all fall within the protection scope of the present invention. In addition, some terms used in the specification and claims of the present application are not limitations, but merely for the purpose of description.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image interpolation method based on RGB-D images and a multi-camera system, comprising:
1) performing camera calibration on each camera in the multi-camera system;
2) clarifying a position of a new camera for interpolation according to position information of the each camera in the multi-camera system, and calculating a camera pose of the new camera according to camera calibration data obtained in step 1);
3) calculating a plurality of initial interpolated images that have a one-to-one correspondence with designated images captured by the each camera of the multi-camera system according to a projection relationship of the camera and the pose information of the each camera;
4) performing image fusion on each initial interpolated image to obtain a fused interpolated image; and
5) performing pixel completion on the fused interpolated image so as to obtain an interpolated image related to the new camera.

2. The image interpolation method based on the RGB-D images and the multi-camera system according to claim 1, wherein the camera pose of the new camera in step 2) comprises a camera intrinsic matrix, a camera translation vector, and a camera rotation matrix, and the camera intrinsic matrix of the new camera is calculated by the following equation (1):
K′=(1−λ)K₁+λK₂ (1)
wherein, in equation (1), K′ represents the camera intrinsic matrix of the new camera;
λ is used to represent the position of the new camera for interpolation, and λ is a ratio of the distance between the new camera and a left camera to the total distance between the left camera and a right camera, 0≤λ≤1;
K₁ represents a camera intrinsic matrix of the left camera which is set on the left side of the new camera; and
K₂ represents a camera intrinsic matrix of the right camera which is set on the right side of the new camera.

3. The image interpolation method based on the RGB-D images and the multi-camera system according to claim 2, wherein the camera translation vector of the new camera is calculated by the following equation (2):
T′=(1−λ)T₁+λT₂ (2)
wherein, in equation (2), T′ represents the camera translation vector of the new camera;
T₁ represents a camera translation vector of the left camera; and
T₂ represents a camera translation vector of the right camera.

4. The image interpolation method based on the RGB-D images and the multi-camera system according to claim 2, wherein the steps of calculating the camera rotation matrix of the new camera comprise:
2.1) calculating a first relative rotation matrix of the right camera relative to the left camera through camera rotation matrices of the left camera and the right camera;
2.2) converting the first relative rotation matrix to a first relative rotation vector, wherein the first relative rotation vector is represented by a rotation axis r=[rₓ,r_{y},r_{z}]^{T} and a rotation angle θ;
2.3) calculating a product of the rotation angle θ and the ratio λ as a rotation angle θ′ of the new camera relative to the left camera, wherein the rotation angle θ′ and the same rotation axis r as the first relative rotation vector are used to represent a second relative rotation vector of the new camera relative to the left camera;
2.4) converting the second relative rotation vector to a second relative rotation matrix; and
2.5) reversely calculating the camera rotation matrix of the new camera according to the second relative rotation matrix and the rotation matrix of the left camera.

5. The image interpolation method based on the RGB-D images and the multi-camera system according to claim 4, wherein the process of calculating the camera rotation matrix of the new camera is represented by the following equation (3):
R′=R₁(Mᵥ₂ᵣ(λMᵣ₂ᵥ(R₂⁻¹·R₁)))⁻¹ (3)
wherein, in equation (3), R′ represents the camera rotation matrix of the new camera;
Mᵥ₂ᵣ represents converting from the first relative rotation matrix to the first relative rotation vector;
Mᵣ₂ᵥ represents converting from the second relative rotation vector to the second relative rotation matrix;
R₁ represents the camera rotation matrix of the left camera transformed from a camera coordinate system to a world coordinate system; and
R₂ represents the camera rotation matrix of the right camera transformed from the camera coordinate system to the world coordinate system.

6. The image interpolation method based on the RGB-D images and the multi-camera system according to claim 5, wherein the steps of calculating the initial interpolated image in step 3) comprise:
3.1) building a projection matrix of the each camera;
3.2) obtaining a three-dimensional discrete point S by back-projecting the built camera projection matrix according to all pixel coordinates and depth values of the designated image captured by a designated camera;
3.3) calculating a pixel coordinate of an image to be generated according to the pose information of the designated camera and the new camera, the three-dimensional discrete point, and the camera projection matrix of the new camera;
3.4) according to the correspondence of the coordinates of the pixel points between the designated image and the image to be generated, filling the pixel value and depth value of the designated image to the corresponding pixel points of the image to be generated so as to obtain the initial interpolated image which has a correspondence with the designated image; and
3.5) repeating steps 3.2) to 3.4) until the plurality of initial interpolated images that have the one-to-one correspondence with the designated images captured by all cameras of the multi-camera system are obtained.

7. The image interpolation method based on the RGB-D images and the multi-camera system according to claim 6, wherein the pixel coordinates of the image to be generated in step 3.3) are calculated by the following equation (4):
$${u}^{′} = \frac{x}{{d}^{′}} {v}^{′} = \frac{y}{{d}^{′}} \qquad ( 4 )$$
wherein, in equation (4), u′ represents a coordinate of the pixel of the image to be generated on the x-axis;
v′ represents a coordinate of the pixel of the image to be generated on the y-axis;
d′ represents a depth value corresponding to the pixel at the position coordinate of u′, v′;
wherein x and y in equation (4) are calculated by the following equation (5):
$$[ \begin{matrix}x \\ y \\ {d}^{′} \\ 1\end{matrix} ] = {P}^{′} {P}_{1}^{- 1} [ \begin{matrix}{u}_{1} {d}_{1} \\ {v}_{1} {d}_{1} \\ {d}_{1} \\ 1\end{matrix} ] \qquad ( 5 )$$
wherein, in equation (5), u′, v′ represent the position coordinate of the pixel of the designated image, u₁ represents a coordinate of the pixel of the designated image on the x-axis, and v₁ represents a coordinate of the pixel of the designated image on the y-axis;
P₁ represents the camera projection matrix of the designated camera;
P′ represents the camera projection matrix of the new camera; and
d₁ represents a depth value corresponding to the pixel at the position coordinate of u₁, v₁.

8. The image interpolation method based on the RGB-D images and the multi-camera system according to claim 7, wherein when there are multiple pixel points projected from the same designated image to the image to be generated at the same position coordinate, only a pixel value of the pixel with the smallest depth value d′ is kept as the pixel value of the pixel point of the image to be generated at the position coordinate.

9. The image interpolation method based on the RGB-D images and the multi-camera system according to claim 6, wherein the method of performing image fusion on the each initial interpolated image in step 4) comprises:
4.1) determining whether the pixel values of the pixels at the same position of the each initial interpolated image are all empty,
if yes, entering an pixel completion process; and
if no, going to step 4.2);
4.2) determining whether the number of the initial interpolated images with non-empty pixel values at the same position is 1, if yes, assigning the non-empty pixel value to the pixel at the same position of the fused interpolated image; and
if no, go to step 4.3); and
4.3) calculating the difference of the depth values between the pixels with non-empty pixel values at the same position of the initial interpolated images, and selecting the corresponding pixel value assignment method according to the threshold judgment result through a threshold judgment method so as to assign the pixel values of the initial interpolated image to the fused interpolated image.

10. The image interpolation method based on the RGB-D images and the multi-camera system according to claim 9, wherein the method of assigning the pixel values of the initial interpolated image to the fused interpolated image in step 4.3) comprises:
if an absolute value of the difference between the depth values of the pixels at the same position of a right image captured by the right camera and a left image captured by the left camera is smaller than or equal to a set threshold ϵ, assigning a weighted average of pixel values of the left image and the right image at the same location to a corresponding pixel point of the fused interpolated image;
if a difference between the pixel values at the same position of the right image and the left image is greater than the threshold ϵ, assigning the pixel value at the same position of the left image to the corresponding pixel point of the fused interpolated image; and
if the difference between the pixel values at the same position of the left image and the right image is smaller than the threshold ϵ, assigning the pixel value at the same position of the right image to the corresponding pixel point of the fused interpolated image.

11. The image interpolation method based on the RGB-D images and the multi-camera system according to claim 9, wherein the steps of performing the pixel completion process on the fused interpolated image comprise:
5.1) generating a window W with the position of the empty pixel as the center;
5.2) calculating an average pixel value of all non-empty pixels inside the window W;
5.3) filling the average pixel value to the center pixel point determined in step 5.1); and
5.4) repeating steps 5.1) to 5.3) until that the pixel completions for all empty pixels of the fused interpolated image are completed.

12. An image interpolation device based on RGB-D images and a multi-camera system, used to implement an image interpolation method, wherein the image interpolation device comprises:
a camera calibration module, configured to perform camera calibration on each camera in the multi-camera system;
a new camera pose calculation module, coupled to the camera calibration module and configured to clarify a position of a new camera according to position information of the each camera in the multi-camera system, and to calculate a camera pose of the new camera according to camera calibration data;
an initial interpolated image calculation module, coupled to the new camera pose calculation module, configured to calculate a plurality of initial interpolated images that have a one-to-one correspondence with designated images captured by the each camera in the multi-camera system according to a projection relationship of the camera and the pose information of the each camera;
an image fusion module, coupled to the initial interpolated image calculation module, configured to perform image fusion on the each initial interpolated image so as to obtain a fused interpolated image; and
an image completion module, coupled to the image fusion module, configured to perform pixel completion on the fused interpolated image and finally obtain an interpolated image associated with the new camera.

13. The image interpolation device of claim 12, wherein the camera pose of the new camera comprises a camera intrinsic matrix, a camera translation vector, and a camera rotation matrix, and the camera intrinsic matrix of the new camera is calculated by the following equation (1):
K′=(1−λ)K₁+λK₂ (1)
wherein, in equation (1), K′ represents the camera intrinsic matrix of the new camera;
λ is used to represent the position of the new camera for interpolation, and λ is a ratio of the distance between the new camera and a left camera to the total distance between the left camera and a right camera, 0≤λ≤1;
K₁ represents a camera intrinsic matrix of the left camera which is set on the left side of the new camera; and
K₂ represents a camera intrinsic matrix of the right camera which is set on the right side of the new camera.

14. The image interpolation device of claim 13, wherein the camera translation vector of the new camera is calculated by the following equation (2):
T′=(1−λ)T₁+λT₂ (2)
wherein, in equation (2), T′ represents the camera translation vector of the new camera;
T₁ represents a camera translation vector of the left camera; and
T₂ represents a camera translation vector of the right camera.

15. The image interpolation device of claim 13, wherein the steps of calculating the camera rotation matrix of the new camera comprise:
2.1) calculating a first relative rotation matrix of the right camera relative to the left camera through camera rotation matrices of the left camera and the right camera;
2.2) converting the first relative rotation matrix to a first relative rotation vector, wherein the first relative rotation vector is represented by a rotation axis r=[rₓ,r_{y},r_{z}]^{T} and a rotation angle θ;
2.3) calculating a product of the rotation angle θ and the ratio λ as a rotation angle θ′ of the new camera relative to the left camera, wherein the rotation angle θ′ and the same rotation axis r as the first relative rotation vector are used to represent a second relative rotation vector of the new camera relative to the left camera;
2.4) converting the second relative rotation vector to a second relative rotation matrix; and
2.5) reversely calculating the camera rotation matrix of the new camera according to the second relative rotation matrix and the rotation matrix of the left camera.

16. The image interpolation device of claim 15, wherein the process of calculating the camera rotation matrix of the new camera is represented by the following equation (3):
R′=R₁(Mᵥ₂ᵣ(λMᵣ₂ᵥ(R₂⁻¹·R₁)))⁻¹ (3)
wherein, in equation (3), R′ represents the camera rotation matrix of the new camera;
Mᵥ₂ᵣ represents converting from the first relative rotation matrix to the first relative rotation vector;
Mᵣ₂ᵥ represents converting from the second relative rotation vector to the second relative rotation matrix;
R₁ represents the camera rotation matrix of the left camera transformed from a camera coordinate system to a world coordinate system; and
R₂ represents the camera rotation matrix of the right camera transformed from the camera coordinate system to the world coordinate system.

17. The image interpolation device of claim 16, wherein the steps of calculating the initial interpolated image comprise:
3.1) building a projection matrix of the each camera;
3.2) obtaining a three-dimensional discrete point S by back-projecting the built camera projection matrix according to all pixel coordinates and depth values of the designated image captured by a designated camera;
3.3) calculating a pixel coordinate of an image to be generated according to the pose information of the designated camera and the new camera, the three-dimensional discrete point, and the camera projection matrix of the new camera;
3.4) according to the correspondence of the coordinates of the pixel points between the designated image and the image to be generated, filling the pixel value and depth value of the designated image to the corresponding pixel points of the image to be generated so as to obtain the initial interpolated image which has a correspondence with the designated image; and
3.5) repeating steps 3.2) to 3.4) until the plurality of initial interpolated images that have the one-to-one correspondence with the designated images captured by all cameras of the multi-camera system are obtained.

18. The image interpolation device of claim 17, wherein the method of performing image fusion on the each initial interpolated image comprises:
4.1) determining whether the pixel values of the pixels at the same position of the each initial interpolated image are all empty,
if yes, entering an pixel completion process; and
if no, going to step 4.2);
4.2) determining whether the number of the initial interpolated images with non-empty pixel values at the same position is 1, if yes, assigning the non-empty pixel value to the pixel at the same position of the fused interpolated image; and
if no, go to step 4.3); and
4.3) calculating the difference of the depth values between the pixels with non-empty pixel values at the same position of the initial interpolated images, and selecting the corresponding pixel value assignment method according to the threshold judgment result through a threshold judgment method so as to assign the pixel values of the initial interpolated image to the fused interpolated image.

19. The image interpolation device of claim 18, wherein the steps of performing the pixel completion process on the fused interpolated image comprise:
5.1) generating a window W with the position of the empty pixel as the center;
5.2) calculating an average pixel value of all non-empty pixels inside the window W;
5.3) filling the average pixel value to the center pixel point determined in step 5.1); and
5.4) repeating steps 5.1) to 5.3) until that the pixel completions for all empty pixels of the fused interpolated image are completed.
